(19) United States
(12) Patent Application Publication
(10) Pub. No.: US 2003/0031113 A1
(43) Pub. Date: Feb. 13, 2003

(54) Disk apparatus capable of automatically adjusting balance at the time of disk rotation

(75) Inventor: Isao Asano, Fukushima-ken (JP)

Correspondence Address: Brinks Hofer Gilson & Lione, P.O. Box 10395, Chicago, IL, 60610, US

(73) Assignee: Alps Electric Co., Ltd.

(21) Appl. No.: 10/214,884

(22) Filed: Aug. 8, 2002

(30) Foreign Application Priority Data
Aug. 10, 2001 (JP) 2001-243276

(51) Int. Cl. G11B 23/00; G11B 25/00

(52) U.S. Cl. 369/263

(57) ABSTRACT

A rotating shaft is rotatably supported to a bearing, and a rotor magnet rotated together with the rotating shaft is provided. A stator coil is provided around an outer periphery of the rotor magnet. The stator coil is partially provided around the rotor magnet and in a region where it does not strike an optical head moved to the innermost peripheral side. Spherical bodies as a balance adjustment unit are provided between the bearing and the rotor magnet.

### BACKGROUND OF THE INVENTION

1. Field of the Invention

The present invention relates to a disk apparatus in which a disk is driven by a rotation driving part, and particularly to a disk apparatus in which means for automatically adjusting balance at the time of disk rotation is provided.

2. Description of the Related Art

A disk apparatus for carrying out reading and writing of a CD (Compact Disk), a DVD (Digital Versatile Disk) or the like is mounted in a personal computer or the like. This kind of disk apparatus is provided with a rotation driving part for rotating a loaded disk at high speed.

FIG. 4 and FIG. 5 are a semi-sectional view showing a rotation driving part mounted in a conventional disk apparatus and a sectional view taken along line 5-5 of FIG. 4. This rotation driving part 50 is mounted in a disk apparatus of a notebook personal computer, and has a size of so-called half inch height. In the rotation driving part 50, a bearing 52 is provided on a base (fixing part) 51, and a rotating shaft 53 is rotatably supported by the bearing 52. A stator coil 55 in which coils 54b are wound around plural cores 54a is provided at an outer periphery of the bearing 52. At an outer periphery of the stator coil 55, a rotor magnet 57 in which a magnet 56b is provided on an inner peripheral surface of a rotor 56a is fixed to the base 51 through the bearing 52. A turn table 58 is provided on an upper part of the rotor magnet 57. A chucking member 58a for detachably supporting a disk is provided on the turn table 58.

However, in the conventional rotation driving part 50, when an inferior disk having an irregular thickness or a disk on which a label is partially pasted is rotated at high speed, there is a problem that oscillation due to the unbalance of the disk occurs, and this oscillation is transmitted to an optical head and a track error occurs.

Then, some disk apparatus thicker than the half inch height adopts measures to provide balance adjustment means in the rotation driving part 50. FIG. 6 and FIG. 7 are a semi-sectional view showing a rotation driving part mounted in a thick disk apparatus, and a sectional view along line 7-7 of FIG. 6. This rotation driving part 60 is provided with a rotation driving mechanism (designated by the same symbol and its explanation is omitted) similar to the rotation driving part 50, and a rotator 61 is supported at an upper part thereof by a rotating shaft 53. A space 62 is annularly formed in the inside of the rotator 61, and plural spherical bodies 63 are movably received in the space 62. The rotator 61 is rotated, so that the unbalance at the time when an inferior disk is loaded is corrected.

Besides, as shown in FIG. 5, in the rotation driving part 50 mounted in this kind of disk apparatus, when an optical head 10 seeks to the innermost periphery of the disk, it moves to the outermost possible peripheral position of the rotation driving part 50. This is a dimension which can not be changed according to the standard of a disk such as a CD or a DVD. By this, the dimension of the outer diameter of the rotation driving part 50 can not be increased.

Thus, in the disk apparatus having enough thickness, although the balance adjustment means is provided at the upper side of the rotation driving part 50 as described above, since the dimension of height of the rotation driving part becomes large, it can not be mounted in a notebook computer or the like.

On the other hand, in a thin disk apparatus mounted in a notebook computer or the like, in the case where the balance adjustment means is provided, since it is difficult to secure a space for the disposition of the stator coil, the balance adjustment means can not be provided.

### SUMMARY OF THE INVENTION

The present invention has been made to solve the above problems, and has an object to provide a disk apparatus which can be used as a thin disk apparatus mounted in a notebook computer or the like and in which even if a disk is rotated at higher speed than a conventional one, oscillation does not occur.

According to the present invention, a disk apparatus comprises a rotation driving part for rotating a disk, and a head moved in a radius direction of the disk, and is characterized in that the rotation driving part includes a bearing provided at a fixing part, a rotating shaft rotatably supported by the bearing, a table provided to the rotating shaft and supporting the disk, a ring-shaped rotor magnet rotated together with the rotating shaft, and a stator coil provided at a fixing side and facing an outer periphery of the rotor magnet, and balance adjustment means rotated together with the rotating shaft is provided inside the rotor magnet.

In this case, when the head is moved to an innermost peripheral side of the disk, it approaches the rotor magnet, and the stator coil is partially disposed within a range of a predetermined angle in the outer periphery of the rotor magnet and in a region where it does not strike the head moved to the innermost peripheral side.

For example, the balance adjustment means is provided in a space formed between an outer periphery of the bearing and an inner periphery of the rotor magnet.

In the above invention, since the space where the balance adjustment means is provided can be secured between the outside of the bearing and the rotor magnet, it can be applied to a thin disk apparatus mounted in a notebook computer or the like. Further, an inferior disk or the like which disorders a rotation balance can be rotated at high speed while keeping its balance. By this, recording and reproduction control of the head at the time of high speed rotation can be certainly carried out.

### BRIEF DESCRIPTION OF THE DRAWINGS

FIG. 1 is a plan view of a part of an inner structure of a disk apparatus of the invention when viewed from a back side.

FIG. 2 is a longitudinal sectional view showing a rotation driving part.

FIG. 3 is a sectional view taken along line 3-3 of FIG. 2.

FIG. 4 is a semi-sectional view showing a rotation driving part mounted in a conventional disk apparatus.

FIG. 5 is a sectional view taken along line 5-5 of FIG. 4.

FIG. 6 is a semi-sectional view showing a rotation driving part mounted in another conventional disk apparatus.

FIG. 7 is a sectional view taken along line 7-7 of FIG. 6.

### DETAILED DESCRIPTION OF THE PREFERRED EMBODIMENTS

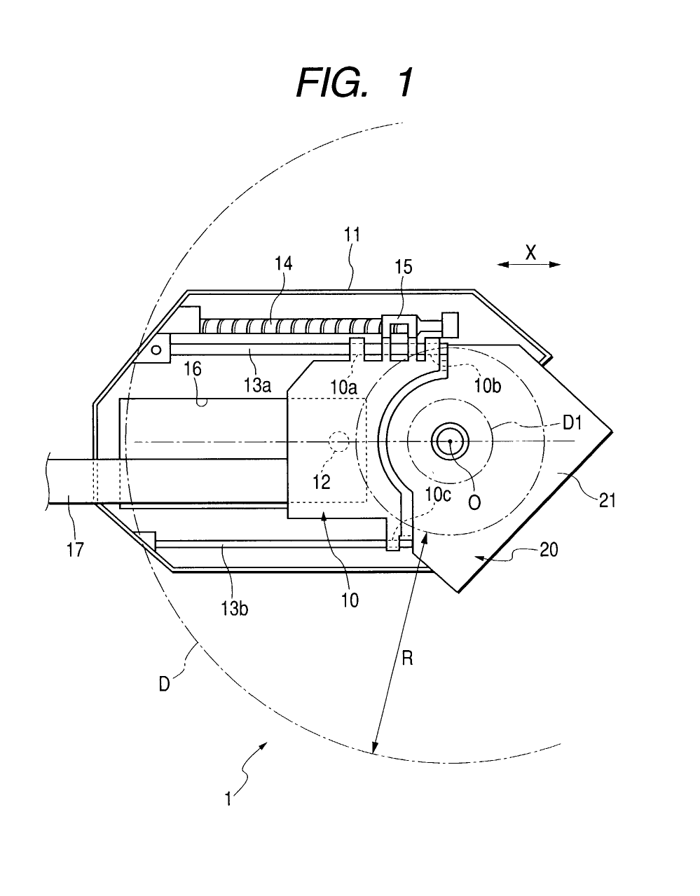

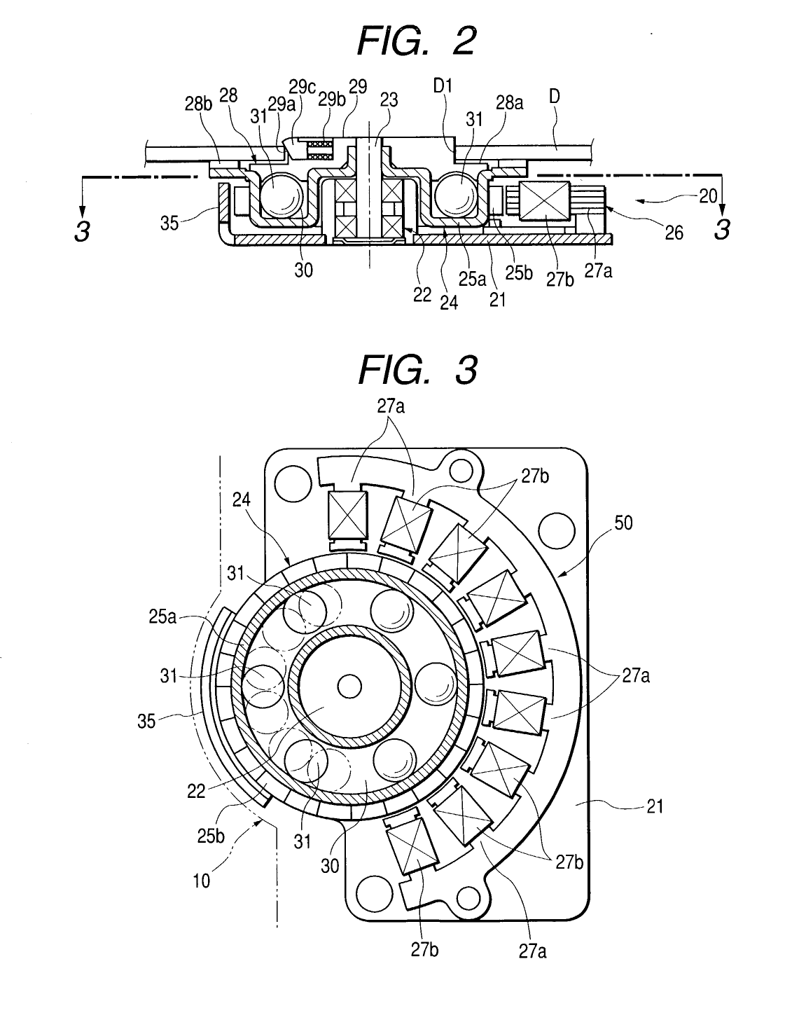

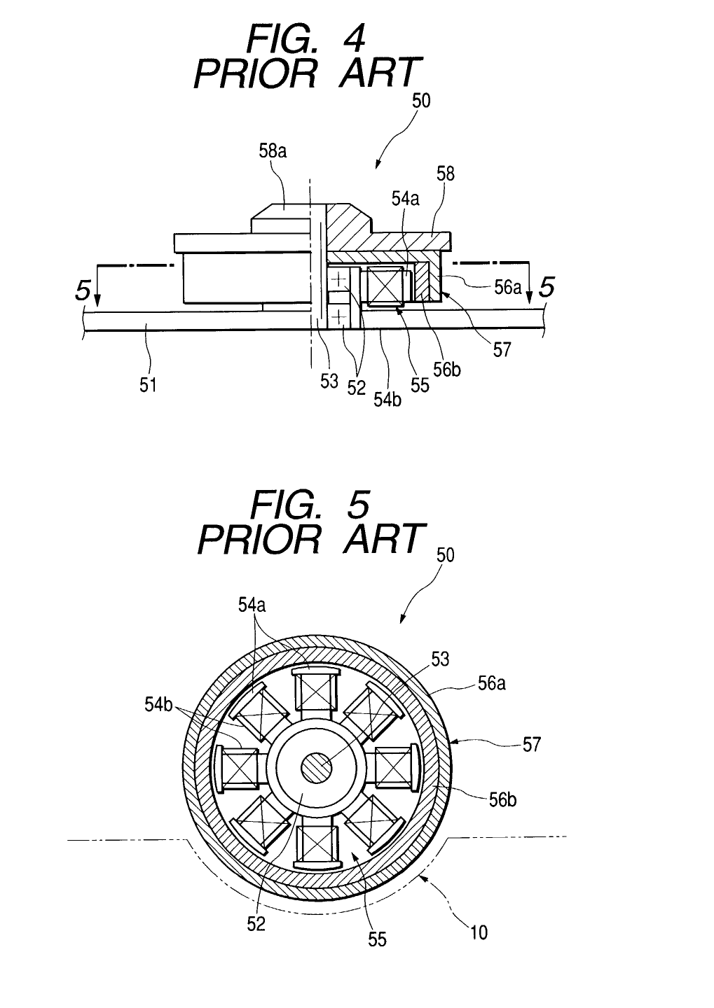

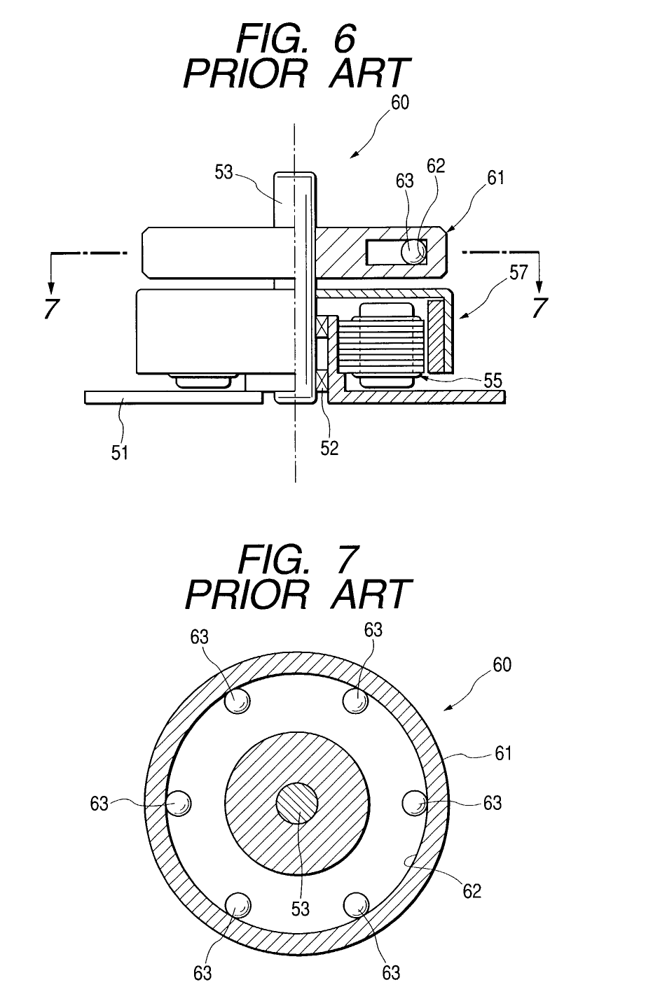

FIG. 1 is a plan view of a part of an inner structure of a disk apparatus of the invention when viewed from a back side, FIG. 2 is a longitudinal sectional view showing a rotation driving part, and FIG. 3 is a sectional view taken along line 3-3 of FIG. 2. In an embodiment described below, a description will be given of a thin disk apparatus, as an example, which is mounted in a notebook computer and in which a disk such as a CD or a DVD can be used.

A disk apparatus 1 shown in FIG. 1 includes an optical head 10 having an objective lens 12, and this optical head 10 is provided on a metal support substrate 11. Two guide members 13a and 13b are provided on the support substrate 11, and a rectangular opening 16 extending in an X direction is formed between the guide members 13a and 13b. Bearing holes 10a and 10b as guide references are formed in the optical head 10, and the guide member 13a is inserted through the bearing holes 10a and 10b. A U-shaped groove 10c is formed in the other side of the optical head 10, and the guide member 13b is inserted through this U-shaped groove 10c with a margin in the horizontal direction. The optical head 10 is guided by the guide members 13a and 13b in the X direction, so that the objective lens 12 is guided in the opening 16 in the X direction.

At a side of the guide member 13a as a reference side of head feed, a screw shaft 14 is disposed parallel on the support substrate 11, the power of a not-shown DC motor is reduced by a reduction gear group and is transmitted to the screw shaft 14, and the screw shaft 14 is rotated and driven. The optical head 10 is provided with a female screw-like locking member 15, and this locking member 15 is engaged with a screw groove of the screw shaft 14.

When the screw shaft 14 is rotated, this rotating force is exerted on the locking member 15 from the screw groove as a feeding force in the X direction, and the optical head 10 is moved in the X direction with the one guide member 13a as a reference. Besides, a band-like flexible substrate 17 is connected to the optical head 10, and can be freely bent in accordance with a slide operation of the optical head 10 so that it does not hinder the operation of the optical head 10.

Signals to correct the objective lens 12 in a tracking direction and a focusing direction are sent through the flexible substrate 17. Besides, laser light from a not-shown light source is irradiated on a disk surface through the objective lens 12, and reflected light from the disk is detected by a not-shown light receiving part.

A rotation driving part 20 is provided adjacently to the optical head 10 on the support substrate 11. The objective lens 12 provided in the optical head 10 is designed to move on a straight line connecting a rotation center O of the rotation driving part 20 and the objective lens 12 and indicated by a two-dot chain line of FIG. 1.

As shown in FIG. 2, in the rotation driving part 20, a bearing 22 is provided on a fixing part 21 formed of a metal plate, and a rotating shaft 23 is rotatably supported by the bearing 22. This bearing 22 may be a bearing a curved surface of which comes in contact with the periphery of the rotating shaft 23 to support it, or may be a bearing with plural spheres provided around the rotating shaft 23, the spheres supporting it.

A ring-shaped rotor magnet 24 rotated together with the rotating shaft 23 is provided to this rotating shaft 23. The rotor magnet 24 is constituted by an assembled body of a rotor 25a covering the bearing 22 from its upper part to its side part, and a ring-shaped magnet 25b fixed to the whole outer peripheral surface. In the rotor magnet 24, a concave-shaped and ring-shaped space 30 is formed between the bearing 22 and the magnet 25b.

On the fixing part 21, a stator coil 26 is provided to face the outer periphery of the magnet 25b of the rotor magnet 24. In the stator coil 26, stator cores 27a formed of magnetic metal material are respectively extended in the radius direction of a disk D to be integrally formed, and a coil 27b is wound around the periphery of each of the stator cores 27a.

A magnetic balancer 35 integrally formed with the fixing part 21 is provided at the opposite side to the stator cores 27a so that the static attracting force of the stator cores 27a and the magnet 25b are almost balanced in the whole periphery.

In this embodiment, as shown in FIG. 3, the stator coil 26 is provided around the rotor magnet 24 and in a region where it does not strike the optical head 10 when the optical head 10 is moved to the innermost peripheral side of the disk D. That is, the stator coil 26 is almost semicircularly and partially provided at the periphery of the rotor magnet 24.

In the disk such as a CD or a DVD, since the ring-shaped region denoted by symbol R of FIG. 1 is a region necessary to move the objective lens 12 of the optical head 10, if the stator coil 26 is provided around the whole periphery of the rotor magnet 24 of the rotation driving part 20, the dimension of the outside diameter of the rotation driving part 20 becomes excessively large and it becomes impossible to cause the optical head 10 to seek to the innermost periphery of the region R. However, in this embodiment, the optical head 10 can be moved in the whole of the region R by partially disposing the stator coil 26 of the rotation driving part 20 as described above.

As stated above, the rotor magnet 24 is disposed in the inside, and the stator coil 26 is disposed at the outer periphery of the rotor magnet 24, so that it becomes possible to provide the space 30 between the outer periphery of the bearing 22 and the rotor magnet 24. In this embodiment, as balance adjustment means, for example, plural steel spherical bodies 31 can be received in the space 30, and the respective spherical bodies 31 can freely move in the space 30. Incidentally, as the balance adjustment means, it is not necessary to restrict the number of the spherical bodies 31 to six, and the number may be more than that or less than that. Besides, in the space 30, the steel spherical bodies 31 may be replaced by spherical bodies of another material or something filled with liquid or the like.

As shown in FIG. 2, a turn table 28 is supported by the rotating shaft 23 to be disposed over the rotor magnet 24. The turn table 28 is provided with a support surface 28a capable of supporting a disk surface at its outer peripheral side, and a chucking member 29 for detachably supporting the disk D at its center side. Incidentally, in this embodiment, a slip resistance member 28b made of rubber is provided to have a ring shape at an outer peripheral edge part of the rotor 25a and at a position opposed to the disk D, and when the turn table 28 is rotated, the disk D does not slide but rotates together.

The chucking member 29 has a convex shape and is shaped into a disk in which its height dimension is slightly longer than the thickness of the disk D and its radius dimension is the same as the diameter of an opening D1 of the disk.

Insertion holes 29a each extending from a side toward a rotation center direction are formed every equal angle at plural places of the chucking member 29, and coil springs 29b are provided in the insertion holes 29a. A small projection 29c is supported at the tip of the coil spring 29b to be capable of moving to/from the side of the chucking member 29. By this, in the case where the disk D is mounted, the disk D is slightly pushed in a state where an edge part of the opening D1 is positioned at the outer peripheral part of the chucking member 29, so that the small projection 29c is pressed into the insertion hole 29a and is retreated, and when the disk D gets over the small projection 29c, the small projection 29c is projected from the insertion hole 29a by repelling force of the coil spring 29b and the disk D is fixed on the turn table 28.

Next, the operation of the rotation driving part 20 of the disk apparatus of this embodiment will be described.

When the disk D is mounted on the turn table 28 and is sent into the computer body, the disk D, together with the rotating shaft 23, the turn table 28 and the rotor magnet 24, is rotated, and information contained in the recording surface of the disk is read by the optical head 10.

In the disk apparatus in which the rotation driving part 20 is mounted, when the disk D is rotated, since the respective spherical bodies 31 are automatically moved in a direction to make the center of gravity of the whole coincident with the rotating shaft 23 by automatic aligning action, the rotation balance can be kept, and the occurrence of vibration can be prevented.

Incidentally, as the rotation driving part 20 shown in FIG. 3, for example, a three-phase brushless motor can be used. As the structure of the brushless motor, the magnet 25b is alternately magnetized to have the N pole and the S pole at a constant pitch in the circumferential direction, the stator cores 27a and the coils 27b of a U phase, a V phase, and a W phase are arranged in turn, and driving currents with phases different from each other by 120° are applied to the respective coils 27b of the U phase, the V phase and the W phase, so that the rotor magnet 24 is rotated in the clockwise direction or the counterclockwise direction on the paper plane of FIG. 3.

In this embodiment, although the description has been given of the case where the rotation driving part 20 is mounted in the thin disk apparatus, it is not limited to this, but may be mounted in a thick disk apparatus mounted in a desktop computer.

The invention described above can be used as a thin disk apparatus mounted in a notebook-sized or space-saving computer, and further, even if a disk is rotated at higher speed than a conventional one, the occurrence of vibration can be prevented, and a track error by that can be prevented.

Besides, even if it is used as a disk apparatus of a writable or rewritable CD or DVD and the disk is rotated at higher speed than a conventional one, stable recording becomes possible.

What is claimed is:

1. A disk apparatus comprising a rotation driving part for rotating a disk, and a head moved in a radius direction of the disk, characterized in that
the rotation driving part includes a bearing provided at a fixing part, a rotating shaft rotatably supported by the bearing, a table provided to the rotating shaft and supporting the disk, a ring-shaped rotor magnet rotated together with the rotating shaft, and a stator coil provided at a fixing side and facing an outer periphery of the rotor magnet, and
balance adjustment means rotated together with the rotating shaft is provided inside the rotor magnet.

2. A disk apparatus as set forth in claim 1, wherein when the head is moved to an innermost peripheral side of the disk, it approaches the rotor magnet, and the stator coil is partially disposed within a range of a predetermined angle in the outer periphery of the rotor magnet and in a region where it does not strike the head moved to the innermost peripheral side.

3. A disk apparatus as set forth in claim 1, wherein the balance adjustment means is provided in a space formed between an outer periphery of the bearing and an inner periphery of the rotor magnet.
